(19) United States
(12) Patent Application Publication
(10) Pub. No.: US 2017/0123534 A1
(43) Pub. Date: May 4, 2017

(54) DISPLAY ZOOM OPERATION WITH BOTH HANDS ON STEERING WHEEL

(71) Applicant: Panasonic Automotive Systems Company of America, Division of Panasonic Corporation of North America, Peachtree City, GA (US)

(72) Inventors: Sachiko KOBAYASHI, Novi, MI (US); David LYON, Huntington Woods, MI (US); Gary L. BRADDOCK, Grosse Pointe, MI (US); Narayani MITAL, Royal Oak, MI (US); Patrick HANSLITS, Clarkston, MI (US)

(73) Assignee: Panasonic Automotive Systems Company of America, Division of Panasonic Corporation of North America

(21) Appl. No.: 15/342,348

(22) Filed: Nov. 3, 2016

Related U.S. Application Data
(60) Provisional application No. 62/250,889, filed on Nov. 4, 2015.

(51) Int. Cl. G06F 3/044; G06F 3/0484; B60K 35/00; G06F 3/0354

(52) U.S. Cl. CPC G06F 3/044; G06F 3/03547; G06F 3/04845; B60K 35/00; G06F 2203/04806; B60K 2350/352; B60K 2350/1036

(57) ABSTRACT

A vehicle includes a steering wheel having a capacitive touch sensor positioned and sized to be touched by a driver's thumb while the remaining fingers on the driver's hand are wrapped around an outer edge of the steering wheel. An electronic processor is communicatively coupled to the display screen and the capacitive touch sensor. The electronic processor zooms in on an image presented on the display screen in response to the driver's thumb being dragged in a first direction across the capacitive touch sensor. The electronic processor zooms out on an image presented on the display screen in response to the driver's thumb being dragged in a second direction across the capacitive touch sensor. The second direction is substantially opposite to the first direction.

### CROSS-REFERENCED TO RELATED APPLICATIONS

This application claims benefit of U.S. Provisional Application No. 62/250,889 filed on Nov. 4, 2015, which the disclosure of which is hereby incorporated by reference in its entirety for all purposes.

### FIELD OF THE INVENTION

The disclosure relates to the field of automotive infotainment systems, and, more particularly, to control apparatus for automotive infotainment systems.

### BACKGROUND OF THE INVENTION

Currently, a driver has to take his hands off the steering wheel in order to reach the center stack or instrument cluster and press a button or manipulate a knob to zoom in/out of a displayed map.

### SUMMARY

The present invention may provide capacitive touchpad switches on a vehicle steering wheel to enable the driver to use his thumbs to zoom in/out an image or text displayed on an instrument cluster while keeping both his hands on the steering wheel. The invention may help the driver keep his hands on the steering wheel while zooming in/out on a displayed map or on any other information or text on the display screen in order that the driver may see more or less information on the display screen.

In one embodiment, the invention comprises a vehicle including a steering wheel having a capacitive touch sensor positioned and sized to be touched by a driver's thumb while the remaining fingers on the driver's hand are wrapped around an outer edge of the steering wheel. An electronic processor is communicatively coupled to a display screen and the capacitive touch sensor. The electronic processor zooms in on an image presented on the display screen in response to the driver's thumb being dragged in a first direction across the capacitive touch sensor. The electronic processor zooms out on an image presented on the display screen in response to the driver's thumb being dragged in a second direction across the capacitive touch sensor. The second direction is substantially opposite to the first direction.

In another embodiment, the invention comprises a vehicle including a steering wheel having a capacitive touchpad switch positioned and sized to be touched by a driver's thumb while the remaining fingers on the driver's hand are wrapped around an outer edge of the steering wheel. An electronic processor is communicatively coupled to a display screen and the capacitive touchpad switch. The electronic processor zooms in on an image presented on the display screen in response to the driver's thumb being dragged in a first direction across the capacitive touchpad switch. The electronic processor zooms out on an image presented on the display screen in response to the driver's thumb being dragged in a second direction across the capacitive touchpad switch. The second direction is substantially opposite to the first direction.

In yet another embodiment, the invention includes a vehicle including a circular steering wheel having a capacitive touch sensor extending less than three inches from the outer circumference of the steering wheel. An electronic processor is communicatively coupled to a display screen and the capacitive touch sensor. The electronic processor zooms in on an image presented on the display screen in response to the driver's thumb being dragged in a first direction across the capacitive touch sensor. The electronic processor zooms out on an image presented on the display screen in response to the driver's thumb being dragged in a second direction across the capacitive touch sensor. The second direction is substantially opposite to the first direction.

The present invention has the advantage that the driver can keep his hands on the steering wheel while zooming in or zooming out on an image.

### BRIEF DESCRIPTION OF THE DRAWINGS

A better understanding of the present invention will be had upon reference to the following description in conjunction with the accompanying drawings.

FIG. 1 is a plan view of one embodiment of a steering wheel and associated display screen of the present invention.

FIG. 2 is a flow chart of one embodiment of a vehicle driver interface control method of the present invention.

### DETAILED DESCRIPTION OF THE PREFERRED EMBODIMENTS

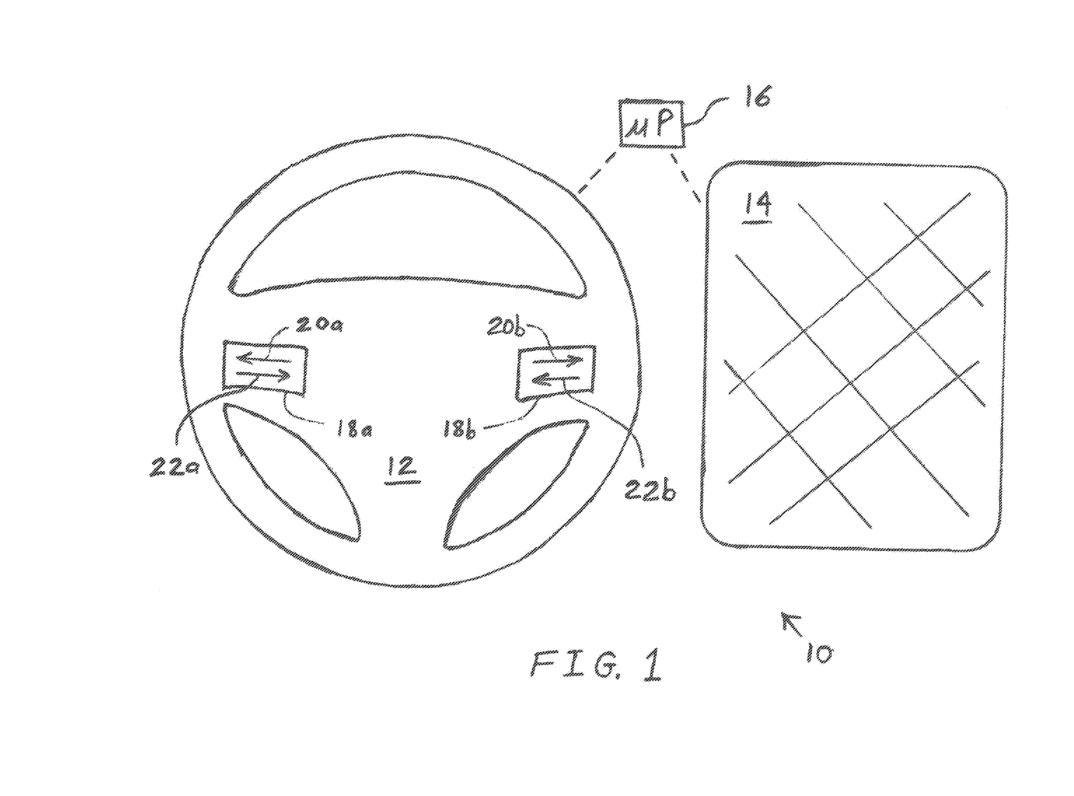

FIG. 1 illustrates one embodiment of a vehicle driver interface 10 of the present invention, including a steering wheel 12, a display screen 14, and an electronic processor 16. Steering wheel 12 includes capacitive touch sensors in the form of capacitive touchpad switches 18a-b near the circumference of steering wheel 12. Processor 16 is communicatively coupled to switches 18a-b and to display screen 14.

Switch 18b may be disposed on steering wheel 12 at a substantially same vertical level as switch 18a when steering wheel 12 is in a position to steer the vehicle in a straight ahead direction. In the embodiment shown, switches 18a-b are substantially rectangular in shape. However, it is to be understood that switches 18a-b can be of a variety of geometric shapes.

Switches 18a-b may be sized and positioned such that the driver can easily touch switches 18a-b with his thumbs while keeping his other fingers wrapped around the circumference of steering wheel 12. In one embodiment, switch 18a is located between eight o'clock and ten o'clock, and switch 18b is located between two o'clock and four o'clock on steering wheel 12. That is, switch 18a is located between 60 degrees and 120 degrees in a counterclockwise direction from the top of steering wheel 12, and switch 18b is located between 60 degrees and 120 degrees in a clockwise direction from the top of steering wheel 12. In other words, each capacitive touchpad switch 18a-b is disposed between 0 degrees and 30 degrees from an imaginary horizontal line bisecting the steering wheel when the steering wheel is steering the vehicle in a straight ahead direction. Thus, the driver may keep his hands at the recommended 9 o'clock and 3 o'clock positions on steering wheel 12 while putting his thumbs on switches 18a-b.

Switches 18a-b may extend no more than three inches in a radially inward direction from the outer circumference of steering wheel 12. Thus, a driver with normally sized hands may easily touch switches 18a-b with his thumbs while keeping his other fingers wrapped around the circumference of steering wheel 12.

In one embodiment, switches 18a-b enable the user to zoom in or zoom out on the image being displayed on display screen 14. For example, the driver may drag one or both of this thumbs in radially outward directions indicated by arrows 20a-b in order to zoom in, or enlarge, the image being presented on display screen 14. Conversely, the driver may drag one or both of this thumbs in radially inward directions indicated by arrows 22a-b in order to zoom out, or shrink, the image being presented on display screen 14. Directions 20a-b are substantially horizontal, radially outward directions, and directions 22a-b are substantially horizontal, radially inward directions.

Switches 18a-b are described herein as being capacitive touchpad switches. However, it is within the scope of the invention for switches 18a-b to be other types of switches, such as rocker switches, resistive touchpads, or dials that the driver may use to zoom in or out on the image being displayed. Any of these alternative types of switches may be operated by the user's thumbs while he keeps his other fingers wrapped around the circumference of the steering wheel.

Although the invention has been described above as detecting the swiping motion of the user's thumb in only two opposite directions, the human-machine interface (HMI) can detect any gesture as long as it is performed by the driver's thumb while his hands are on the wheel. For example, circular motion by at least one of the thumbs may be detected. However, a straight swipe of the thumb may be better from an ergonomics point of view, and may be more intuitive to the driver.

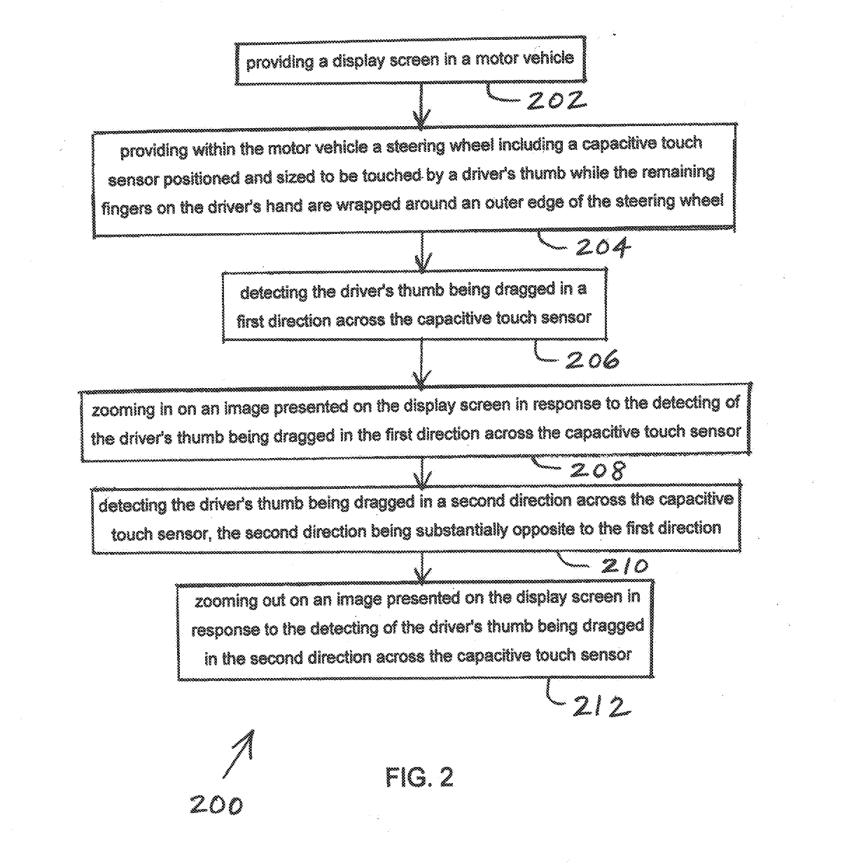

FIG. 2 illustrates one embodiment of a vehicle driver interface control method 200 of the present invention. In a first step 202, a display screen is provided in a motor vehicle. For example, display screen 14 may be provided in vehicle driver interface 10.

Next, in step 204, a steering wheel is provided including a capacitive touch sensor positioned and sized to be touched by a driver's thumb while the remaining fingers on the driver's hand are wrapped around an outer edge of the steering wheel. For example, steering wheel 12 includes capacitive touch sensors in the form of capacitive touchpad switches 18a-b near the circumference of steering wheel 12.

In a next step 206, the driver's thumb being dragged in a first direction across the capacitive touch sensor is detected. For example, capacitive touchpad switch 18a may detect the driver's thumb being dragged across capacitive touchpad switch 18a in direction 20a.

In step 208, an image presented on the display screen is zoomed in on in response to the driver's thumb being dragged in a first direction across the capacitive touch sensor. That is, in response to detecting the driver's thumb being dragged across capacitive touchpad switch 18a in direction 20a, processor 16 may enlarge the image being presented on display screen 14.

Next, in step 210, the driver's thumb being dragged in a second direction across the capacitive touch sensor is detected, wherein the second direction is substantially opposite to the first direction. For example, capacitive touchpad switch 18a may detect the driver's thumb being dragged across capacitive touchpad switch 18a in direction 22a.

In a final step 212, an image presented on the display screen is zoomed out on in response to the driver's thumb being dragged in the second direction across the capacitive touch sensor. That is, in response to detecting the driver's thumb being dragged across capacitive touchpad switch 18a in direction 22a, processor 16 may reduce the image being presented on display screen 14.

The foregoing description may refer to “motor vehicle”, “automobile”, “automotive”, or similar expressions. It is to be understood that these terms are not intended to limit the invention to any particular type of transportation vehicle. Rather, the invention may be applied to any type of transportation vehicle whether traveling by air, water, or ground, such as airplanes, boats, etc.

The foregoing detailed description is given primarily for clearness of understanding and no unnecessary limitations are to be understood therefrom for modifications can be made by those skilled in the art upon reading this disclosure and may be made without departing from the spirit of the invention.

What is claimed is:

1. A vehicle, comprising:
a display screen;
a steering wheel including a capacitive touch sensor positioned and sized to be touched by a driver's thumb while the remaining fingers on the driver's hand are wrapped around an outer edge of the steering wheel; and
an electronic processor communicatively coupled to the display screen and the capacitive touch sensor, the electronic processor being configured to:
zoom in on an image presented on the display screen in response to the driver's thumb being dragged in a first direction across the capacitive touch sensor; and
zoom out on an image presented on the display screen in response to the driver's thumb being dragged in a second direction across the capacitive touch sensor, the second direction being substantially opposite to the first direction.

2. The vehicle of claim 1 wherein the capacitive touch sensor has a substantially rectangular shape.

3. The vehicle of claim 1, wherein the capacitive touch sensor extends no farther than three inches from a nearest outer edge of the steering wheel.

4. The vehicle of claim 3 wherein the steering wheel has a circular outer edge, and the capacitive touch sensor is disposed between 0 degrees and 30 degrees from an imaginary horizontal line bisecting the steering wheel when the steering wheel is steering the vehicle in a straight ahead direction.

5. The vehicle of claim 1 wherein the capacitive touch sensor comprises a capacitive touchpad switch.

6. The vehicle of claim 1 wherein the zooming in on the image comprises enlarging the image, and the zooming out on the image comprises reducing the image.

7. The vehicle of claim 1 wherein the first direction is substantially a horizontal radially outward direction, and the second direction is substantially a horizontal radially inward direction.

8. A vehicle, comprising:
a display screen;
a steering wheel including a capacitive touchpad switch positioned and sized to be touched by a driver's thumb while the remaining fingers on the driver's hand are wrapped around an outer edge of the steering wheel; and
an electronic processor communicatively coupled to the display screen and the capacitive touchpad switch, the electronic processor being configured to:
zoom in on an image presented on the display screen in response to the driver's thumb being dragged in a first direction across the capacitive touchpad switch; and
zoom out on an image presented on the display screen in response to the driver's thumb being dragged in a second direction across the capacitive touchpad switch, the second direction being substantially opposite to the first direction.

9. The vehicle of claim 8 wherein the capacitive touchpad switch has a substantially rectangular shape.

10. The vehicle of claim 8, wherein the capacitive touchpad switch extends no farther than three inches from a nearest outer edge of the steering wheel.

11. The vehicle of claim 10 wherein the steering wheel has a circular outer edge, and the capacitive touchpad switch is disposed between 0 degrees and 30 degrees from an imaginary horizontal line bisecting the steering wheel when the steering wheel is steering the vehicle in a straight ahead direction.

12. The vehicle of claim 8 further comprising a second capacitive touchpad switch disposed on the steering wheel at a substantially same vertical level as the first capacitive touchpad switch when the steering wheel is in a position to steer the vehicle in a straight ahead direction.

13. The vehicle of claim 8 wherein the zooming in on the image comprises enlarging the image, and the zooming out on the image comprises reducing the image.

14. The vehicle of claim 8 wherein the first direction is substantially a radially outward direction, and the second direction is substantially a radially inward direction.

15. A vehicle, comprising:
a display screen;
a circular steering wheel including a capacitive touch sensor extending less than three inches from an outer circumference of the steering wheel; and
an electronic processor communicatively coupled to the display screen and the capacitive touch sensor, the electronic processor being configured to:
zoom in on an image presented on the display screen in response to the driver's thumb being dragged in a first direction across the capacitive touch sensor; and
zoom out on an image presented on the display screen in response to the driver's thumb being dragged in a second direction across the capacitive touch sensor, the second direction being substantially opposite to the first direction.

16. The vehicle of claim 15 wherein the capacitive touch sensor has a substantially rectangular shape.

17. The vehicle of claim 15 wherein the capacitive touch sensor is disposed approximately between 0 degrees and 30 degrees from an imaginary horizontal line bisecting the steering wheel when the steering wheel is steering the vehicle in a straight ahead direction.

18. The vehicle of claim 15 wherein the capacitive touch sensor comprises a capacitive touchpad switch.

19. The vehicle of claim 15 wherein the zooming in on the image comprises enlarging at least a portion of the image, and the zooming out on the image comprises making at least a portion of the image smaller.

20. The vehicle of claim 15 wherein the first direction is substantially a radially outward direction, and the second direction is substantially a radially inward direction.
